(19) United States
(12) Patent Application Publication
(10) Pub. No.: US 2020/0251718 A1
(43) Pub. Date: Aug. 6, 2020

(54) POSITIVE ELECTRODE MATERIAL FOR LITHIUM-ION SECONDARY BATTERIES, POSITIVE ELECTRODE FOR LITHIUM-ION SECONDARY BATTERIES, AND LITHIUM-ION SECONDARY BATTERY

(71) Applicant: SUMITOMO OSAKA CEMENT CO., LTD., Tokyo (JP)

(72) Inventors: Tsutomu NOZOE, Chiba (JP); Toyomasa NAKANO, Chiba (JP)

(73) Assignee: SUMITOMO OSAKA CEMENT CO., LTD., Tokyo (JP)

(21) Appl. No.: 16/577,226

(22) Filed: Sep. 20, 2019

(30) Foreign Application Priority Data
Feb. 5, 2019 (JP) 2019-018918

(51) Int. Cl. H01M 4/133; H01M 10/0525; H01M 4/131; H01M 4/485

(52) U.S. Cl. CPC H01M 4/133; H01M 10/0525; H01M 2004/028; H01M 4/485; H01M 4/131

(57) ABSTRACT

A positive electrode material for lithium-ion secondary batteries includes a granulated body in which a volume of pores having a pore size of 2 nm to 100 nm calculated from a cumulative pore volume distribution is 0.1 cm³/g or higher and 0.2 cm³/g or lower and a ratio of a volume of pores having a pore size of 20 nm to 70 nm is 65% or higher with respect to 100% of the volume of pores having a pore size of 2 nm to 100 nm.

### TECHNICAL FIELD

The present invention relates to a positive electrode material for lithium-ion secondary batteries, a positive electrode for lithium-ion secondary batteries, and a lithium-ion secondary battery.

### BACKGROUND ART

A lithium-ion secondary battery that is a non-aqueous electrolyte secondary battery can achieve a reduction in size and weight and an increase in capacity and further has excellent properties such as high output and high energy density. Therefore, a lithium-ion secondary battery has been commercialized not only in an electric vehicle but also as a high-output power supply such as an electric tool. As a positive electrode material for lithium-ion secondary batteries, for example, a material including a granulated body produced using primary particles is known, the primary particles including an electrode active material and a carbon film that coats a surface of the electrode active material.

In a case where a positive electrode for lithium-ion secondary batteries is prepared using a positive electrode material for lithium-ion secondary batteries, in order to improve the energy density per volume of the electrode or to improve to reduce unevenness in a positive electrode mixture layer for improvement of durability, the positive electrode material for lithium-ion secondary batteries is generally compressed using a roll press or the like when applied to a current collector (for example, refer to Patent Document 1).

### RELATED ART DOCUMENT

### Patent Document

[Patent Document 1] Japanese Laid-open Patent Publication No. 2018-056051

### DISCLOSURE OF THE INVENTION

### Problem that the Invention is to Solve

Here, when a granulated body obtained by agglomerating primary particles of lithium iron phosphate (LFP) is used as an electrode active material, in a case where the granulated body is brittle, pores in the granulated body collapse during pressing, and thus an electrolytic solution is not likely to penetrate into the granulated body.

The present invention has been made in consideration of the above-described circumstances, and an object thereof is to provide a positive electrode material for lithium-ion secondary batteries in which an electrolytic solution can be made to easily penetrates into a granulated body even after pressing, a positive electrode for lithium-ion secondary batteries, and a lithium-ion secondary battery.

### Means for Solving the Problem

In order to achieve the object, the present inventors conducted a thorough investigation and found that a positive electrode material for lithium-ion secondary batteries in which an electrolytic solution can be made to easily penetrates into a granulated body even after pressing can be obtained by including a granulated body in which a volume of pores having a pore size of 2 nm to 100 nm calculated from a cumulative pore volume distribution is 0.1 cm³/g or higher and 0.2 cm³/g or lower and a ratio of a volume of pores having a pore size of 20 nm to 70 nm is 65% or higher with respect to 100% of the volume of pores having a pore size of 2 nm to 100 nm. Based on the findings, the present invention has been completed.

According to the present invention, there is provided a positive electrode material for lithium-ion secondary batteries including a granulated body in which a volume of pores having a pore size of 2 nm to 100 nm calculated from a cumulative pore volume distribution is 0.1 cm³/g or higher and 0.2 cm³/g or lower and a ratio of a volume of pores having a pore size of 20 nm to 70 nm is 65% or higher with respect to 100% of the volume of pores having a pore size of 2 nm to 100 nm.

A positive electrode for lithium-ion secondary batteries according to the present invention is a positive electrode for lithium-ion secondary batteries, the positive electrode including: an electrode current collector; and a positive electrode mixture layer that is formed on the electrode current collector, in which the positive electrode mixture layer includes the positive electrode material for lithium-ion secondary batteries.

A lithium-ion secondary battery according to the present invention is a lithium-ion secondary battery including: a positive electrode; a negative electrode; and a non-aqueous electrolyte, in which the positive electrode for lithium-ion secondary batteries according to the present invention is provided as the positive electrode.

### Advantage of the Invention

In the positive electrode material for lithium-ion secondary batteries according to the present invention, an electrolytic solution can be made to easily penetrate into a granulated body even after pressing.

The positive electrode for lithium-ion secondary batteries according to the present invention includes the positive electrode material for lithium-ion secondary batteries according to the present invention. Therefore, an electrolytic solution easily penetrates into the granulated body included in the positive electrode for lithium-ion secondary batteries, and a positive electrode for lithium-ion secondary batteries in which the electron conductivity and the ion conductivity are realized and the energy density is improved can be provided.

The lithium-ion secondary battery according to the present invention includes the positive electrode for lithium-ion secondary batteries according to the present invention. Therefore, the lithium-ion secondary battery can be provided in which the discharge capacity is high and the charge-discharge direct current resistance is low.

### BEST MODE FOR CARRYING OUT THE INVENTION

An embodiment of a positive electrode material for lithium-ion secondary batteries, a positive electrode for lithium-ion secondary batteries, and a lithium-ion secondary battery according to the present invention will be described. The embodiment will be described in detail for easy understanding of the concept of the present invention, but the present invention is not limited thereto unless specified otherwise.

[Positive Electrode Material for Lithium-Ion Secondary Batteries]

A positive electrode material for lithium-ion secondary batteries according to the embodiment includes granules in which a volume of pores having a pore size of 2 nm to 100 nm calculated from a cumulative pore volume distribution is 0.1 cm³/g or higher and 0.2 cm³/g or lower and a ratio of a volume of pores having a pore size of 20 nm to 70 nm is 65% or higher with respect to 100% of the volume of pores having a pore size of 2 nm to 100 nm.

In the granules according to the embodiment, a cumulative volume of pores having a pore size of 2 nm to 100 nm calculated from a cumulative pore volume distribution is 0.1 cm³/g or higher and 0.2 cm³/g or lower and more preferably 0.1 cm³/g or higher and 0.17 cm³/g or lower.

When the volume of pores is lower than 0.1 cm³/g, an electrolytic solution is not likely to penetrate into pores between the primary particles such that the electron conductivity decreases. On the other hand, when the volume of pores is higher than 0.2 cm³/g, the granule density decreases, and the electrode energy density decreases.

In the granules according to the embodiment, a ratio of a volume of pores having a pore size of 20 nm to 70 nm is 65% or higher, preferably 67% or higher, and still more preferably 69% or higher with respect to 100% of the volume of pores having a pore size of 2 nm to 100 nm.

When the ratio of the volume of pores having a pore size of 20 nm to 70 nm is 65% or higher with respect to 100% of the volume of pores having a pore size of 2 nm to 100 nm, density unevenness of granule structures is small, and granules are not likely to be broken during pressing.

The cumulative pore volume distribution of the granules according to the embodiment is measured using a Barrett Joyner Hallenda (BJH) method by performing nitrogen adsorption/desorption measurement.

When a pressure of 25 MPa is applied to the granules according to the embodiment, a retention of a volume of pores having a pore size of 20 nm to 70 nm calculated from a cumulative pore volume distribution is preferably 75% or higher and more preferably 78% or higher.

When the retention of the volume of pores is 75% or higher, the carbon film that coats the primary particles is not likely to peel off.

When a pressure of 25 MPa is applied to the granules according to the embodiment, the retention of the volume of pores having a pore size of 20 nm to 70 nm refers to a value obtained by dividing the volume of pores having a pore size of 20 nm to 70 nm when a pressure of 25 MPa is applied the volume of pores having a pore size of 20 nm to 70 nm before a pressure of 25 MPa is applied. That is, the retention is calculated from the following Expression (1).

(Volume of Pores having Pore Size of 20 nm to 70 nm when Pressure of 25 MPa is Applied)/(Volume of Pores having Pore Size of 20 nm to 70 nm before Pressure of 25 MPa is Applied)×100 [%] (1)

The granules according to the embodiment includes a positive electrode active material (primary particles) and a carbon film (pyrolytic carbon film) that coats a surface of the positive electrode active material. In addition, the positive electrode material for lithium-ion secondary batteries according to the embodiment includes a granulated body that is produced using the above-described granules. Hereinafter, the granules (primary particles) including the positive electrode active material (primary particles) and the pyrolytic carbon film for coating the surface of the positive electrode active material will also be referred to as “the primary particles of the carbon-coated positive electrode active material”.

In the positive electrode material for lithium-ion secondary batteries according to the embodiment, the average particle diameter of the primary particles of the carbon-coated positive electrode active material is 30 nm or more and 500 nm or less, preferably 50 nm or more and 400 nm or less, and more preferably 50 nm or more and 300 nm or less.

Here, the reason why the average particle diameter of the primary particles of the carbon-coated positive electrode active material is in the above-described range is as follows. When the average primary particle diameter is 30 nm or more, an increase in the amount of carbon caused by an excessive increase in specific surface area can be suppressed. On the other hand, when the average primary particle diameter is 500 nm or less, the electron conductivity and the ion diffusion performance can be improved due to a large specific surface area.

The average particle diameter of the primary particles of the carbon-coated positive electrode active material can be obtained by measuring the particle diameters of 200 or more any primary particles using a scanning electron microscope (SEM) and obtaining the number average value thereof.

In the positive electrode material for lithium-ion secondary batteries according to the embodiment, the average particle diameter of the granulated body formed of the primary particles of the carbon-coated positive electrode active material is 0.5 μm or more and 60 μm or less, preferably 1 μm or more and 20 μm or less, and more preferably 1 μm or more and 10 μm or less.

Here, the reason why the average particle diameter of the granulated body is in the above-described range is as follows. In a case where the average particle diameter of the granulated body is 0.5 μm or more, when the positive electrode material, a conductive auxiliary agent, a binder resin (binder), and a solvent are mixed with each other to prepare a positive electrode material paste for lithium-ion secondary batteries, the mixing amount of the conductive auxiliary agent and the binder can be reduced, and the battery capacity of the lithium-ion secondary battery per unit mass of the positive electrode mixture layer for lithium-ion secondary batteries can be increased. On the other hand, when the average particle diameter of the granulated body is 60 μm or less, the dispersibility and the uniformity of the conductive auxiliary agent or the binder included in the positive electrode mixture layer for lithium-ion secondary batteries can be improved. As a result, in the lithium-ion secondary battery in which the positive electrode material for lithium-ion secondary batteries according to the embodiment is used, the discharge capacity during high-speed charge and discharge can be increased.

The average particle diameter of the granulated body is measured using a laser diffraction particle diameter analyzer after suspending the positive electrode material for lithium-ion secondary batteries according to the embodiment in a dispersion medium in which 0.1% by mass of polyvinyl pyrrolidone is dissolved in water.

In the positive electrode material for lithium-ion secondary batteries according to the embodiment, the carbon content in the primary particles of the carbon-coated positive electrode active material is preferably 0.5% by mass or more and 2.5% by mass or less, preferably 0.8% by mass or more and 1.3% by mass or less, and still more preferably 0.8% by mass or more and 1.2% by mass or less.

Here, the reason why the carbon content in the primary particles of the carbon-coated positive electrode active material is in the above-described range is as follows. When the carbon content in the primary particles is 0.5% by mass or more, the electron conductivity can be sufficiently improved. On the other hand, when the carbon content in the primary particles of the carbon-coated positive electrode active material is 2.5% by mass or less, the electrode density can be improved.

The carbon content in the primary particles of the carbon-coated positive electrode active material is measured using a carbon analyzer (carbon-sulfur analyzer: EMIA-810W (trade name), manufactured by Horiba Ltd.).

In the positive electrode material for lithium-ion secondary batteries according to the embodiment, the coating ratio of the carbon film in the primary particles of the carbon-coated positive electrode active material is preferably 80% or more, more preferably 85% or more, and still more preferably 90% or more.

Here, the reason why the coating ratio of the carbon film in the primary particles of the carbon-coated positive electrode active material is in the above-described range is as follows. When the coating ratio of the carbon film in the primary particles of the carbon-coated positive electrode active material is 80% or more, the coating effect of the carbon coating can be sufficiently obtained.

The coating ratio of the carbon film in the primary particles of the carbon-coated positive electrode active material is measured, for example, using a transmission electron microscope (TEM) or an energy dispersive X-ray microanalyzer (EDX).

In the positive electrode material for lithium-ion secondary batteries according to the embodiment, the thickness of the carbon film in the primary particles of the carbon-coated positive electrode active material is preferably 0.8 nm or more and 5.0 nm or less, more preferably 0.9 nm or more and 4.5 nm or less, and still preferably 0.8 nm or more and 4.0 nm or less.

Here, the reason why the thickness of the carbon film in the primary particles of the carbon-coated positive electrode active material is in the above-described range is as follows. When the thickness of the carbon film in the primary particles is 0.8 nm or more, the thickness of the carbon film is excessively thin, and thus a carbon film having a desired resistance value can be formed. On the other hand, when the thickness of the carbon film in the primary particles of the carbon-coated positive electrode active material is 5.0 nm or less, a decrease in the battery capacity per unit mass of the electrode material can be suppressed.

The thickness of the carbon film in the primary particles of the carbon-coated positive electrode active material is measured, for example, using a transmission electron microscope (TEM) or an energy dispersive X-ray microanalyzer (EDX).

The positive electrode material for lithium-ion secondary batteries according to the embodiment may include a component other than the above-described granulated body. Examples of the component other than the granulated body include a binder formed of a binder resin and a conductive auxiliary agent such as carbon black, acetylene black, graphite, Ketjen black, natural graphite, or artificial graphite.

The specific surface area of the granulated body in the positive electrode material for lithium-ion secondary batteries according to the embodiment is preferably 6 m²/g or more and 30 m²/g or less and more preferably 10 m²/g or more and 20 m²/g or less.

Here, the reason why the specific surface area of the positive electrode material for lithium-ion secondary batteries according to the embodiment is limited to the above-described range is as follows. When the specific surface area is 6 m²/g or more, the diffusion rate of lithium ions in the positive electrode material can be increased, and the battery characteristics of the lithium-ion secondary battery can be improved. On the other hand, when the specific surface area is 30 m²/g or less, the electron conductivity can be improved.

Using a specific surface area meter, the specific surface area of the positive electrode material for lithium-ion secondary batteries according to the embodiment is measured with a BET method using nitrogen (N₂) adsorption.

[Positive Electrode Active Material]

In the positive electrode material for lithium-ion secondary batteries according to the embodiment, it is preferable that an olivine positive electrode active material is provided as the positive electrode active material.

The olivine positive electrode active material is formed of a compound represented by Formula LiₓA_{y}D_{z}PO₄ (where A represents at least one selected from the group consisting of Co, Mn, Ni, Fe, Cu, and Cr, D represents at least one selected from the group consisting of Mg, Ca, Sr, Ba, Ti, Zn, B, Al, Ga, In, Si, Ge, Sc, and Y, 0.9<x<1.1, 0<y≤1, 0≤z<1, and 0.9<y+z<1.1).

From the viewpoints of high discharge capacity and high energy density, it is preferable that the positive electrode active material satisfies 0.9<x<1.1, 0<y≤1, 0≤z<1, and 0.9<y+z<1.1 in LiₓA_{y}D_{z}PO₄.

From the viewpoint that a positive electrode mixture layer that can realize high discharge potential and high safety, Co, Mn, Ni, or Fe is preferable as A, and Mg, Ca, Sr, Ba, Ti, Zn, or Al is preferable as D.

The crystallite diameter of the olivine positive electrode active material is preferably 30 nm or more and 150 nm or less and more preferably 50 nm or more and 120 nm or less.

When the crystallite diameter of the olivine positive electrode active material is less than 30 nm, a large amount of carbon is required to sufficiently coat the surface of the positive electrode active material with the pyrolytic carbon film. In addition, since a large amount of a binder is required, the amount of the positive electrode active material in the positive electrode decreases, and the battery capacity may decrease. Likewise, the carbon film may peel off due to an insufficient binding strength. On the other hand, when the crystallite diameter of the olivine positive electrode active material is more than 150 nm, the internal resistance of the positive electrode active material excessively increases, and thus when a battery is formed, the discharge capacity in the high charge-discharge rate may decrease.

The crystallite diameter of the olivine positive electrode active material is calculated from the Scherrer equation using a full width at half maximum of a diffraction peak and a diffraction angle (2θ) of the (020) plane in a powder X-ray diffraction pattern that is measured by X-ray diffraction measurement.

### [Carbon Film]

The carbon film is a pyrolytic carbon film that is obtained by carbonizing an organic compound as a raw material. It is preferable that a carbon source that is a raw material of the carbon film is derived from an organic compound in which the purity of carbon is 40.00% or higher and 60.00% or lower.

In the positive electrode material for lithium-ion secondary batteries according to the embodiment, as a method of calculating “purity of carbon” in the carbon source that is a raw material of the carbon film, when plural kinds of organic compounds are used, a method of calculating and adding the amounts of carbon (% by mass) in the mixing amounts of the respective organic compounds based on the mixing amounts (% by mass)of the respective organic compounds and the known purities (%) of carbon and calculating the “purity of carbon” in the carbon source from the following Expression (2) based on the total mixing amount (% by mass) and the total amount of carbon (% by mass of the organic compounds is used.

Purity of Carbon (%)=Total amount of Carbon (% by mass)/Total Mixing Amount (% by mass)×100 (2)

The positive electrode material for lithium-ion secondary batteries according to the embodiment includes granules in which a volume of pores having a pore size of 2 nm to 100 nm calculated from a cumulative pore volume distribution is 0.1 cm³/g or higher and 0.2 cm³/g or lower and a ratio of a volume of pores having a pore size of 20 nm to 70 nm is 65% or higher with respect to 100% of the volume of pores having a pore size of 2 nm to 100 nm. Therefore, an electrolytic solution can be made to easily penetrate into the granules even after pressing. Therefore, with the positive electrode material for lithium-ion secondary batteries according to the embodiment, a positive electrode for lithium-ion secondary batteries in which the electron conductivity and the ion conductivity are realized and the energy density is improved can be obtained. Further, with the positive electrode material for lithium-ion secondary batteries according to the embodiment, a lithium-ion secondary battery can be provided in which the discharge capacity is high and the charge-discharge direct current resistance is low.

[Method of Producing Electrode Material for Lithium-Ion Secondary Batteries]

A method of producing the electrode material for lithium-ion secondary batteries according to the embodiment is not particularly limited, and examples thereof include a method including: a step of preparing a dispersion by mixing LiₓA_{y}D_{z}PO₄ particles and an organic compound with each other and dispersing the mixture; a step of obtaining a dry material by drying the dispersion; a step of calcinating the dry material in a non-oxidative atmosphere to obtain a granulated body that is produced using primary particles of a carbon-coated electrode active material; and a step of mixing the obtained granulated body with an oxide electrode active material.

The LiₓA_{y}D_{z}PO₄ particles are not particularly limited. For example, it is preferable that the LiₓA_{y}D_{z}PO₄ particles are obtained by introducing a Li source, an A source, a D source, and a PO₄ source into water such that a molar ratio x:y+z thereof is 1:1, stirring the components to obtain a LiₓA_{y}D_{z}PO₄ precursor solution, putting this precursor solution into a pressure-resistant container, and performing a hydrothermal treatment at a high temperature and a high pressure, for example, at 120° C. to 250° C. and 0.2 MPa for 1 hour to 24 hours.

In this case, by adjusting the temperature, the pressure, and the time during the hydrothermal treatment, the particle diameter of the LiₓA_{y}D_{z}PO₄ particles can be controlled to be a desired diameter.

In this case, as the Li source, for example, at least one selected from the group consisting of a lithium inorganic acid salt such as lithium hydroxide (LiOH), lithium carbonate (Li₂CO₃), lithium chloride (LiCl), or Lithium phosphate (Li₃PO₄) and a lithium organic acid salt such as lithium acetate (LiCH₃COO) or lithium oxalate ((COOLi)₂).

Among these, lithium chloride or lithium acetate is preferable from the viewpoint of obtaining a uniform solution phase.

Here, as the A source, at least one selected from the group consisting of a Co source formed of a cobalt compound, a Mn source formed of a manganese compound, a Ni source formed of a nickel compound, a Fe source formed of an iron compound, a Cu source formed of a copper compound, and a Cr source formed of a chromium compound is preferable. In addition, as the D source, at least one selected from the group consisting of a Mg source formed of a magnesium compound, a Ca source formed of a calcium compound, a Sr source formed of a strontium compound, a Ba source formed of a barium compound, a Ti source formed of a titanium compound, a Zn source formed of a zinc compound, a B source formed of a boron compound, an Al source formed of an aluminum compound, a Ga source formed of a gallium compound, an In source formed of an indium compound, a Si source formed of a silicon compound, a Ge source formed of a germanium compound, a Sc source formed of a scandium compound, and a Y source formed of a yttrium compound is preferable.

As the PO₄ source, for example, at least one selected from the group consisting of yellow phosphorus, red phosphorus, phosphoric acids such as orthophosphoric acid (H₃PO₄) or metaphosphoric acid (HPO₃), ammonium dihydrogen phosphate (NH₄H₂PO₄), diammonium hydrogen phosphate ((NH₄)₂HPO₄), ammonium phosphate ((NH₄)₃PO₄), lithium phosphate (Li₃PO₄), dilithium hydrogen phosphate (Li₂HPO₄), lithium dihydrogen phosphate (LiH₂PO₄), and hydrates thereof is preferable.

In particular, orthophosphoric acid is preferable from the viewpoint of easily forming a uniform solution phase.

LiFePO₄ precursor particles refer to a state where a mixed liquid including the Li source, the Fe source, the PO₄ source, and water is heated at a low temperature where LiFePO₄ particles are not formed.

The LiFePO₄ precursor particles can be obtained using a method including: introducing the Li source, the Fe source, and the PO₄ source into water such that a molar ratio thereof is 1:1:1; stirring the components to obtain a LiFePO₄ particle precursor solution; and heating the precursor solution at 60° C. or higher and 90° C. or lower for 1 hour or longer and 24 hours or shorter.

The reason why the preparation of the LiFePO₄ precursor particles is preferable is as described below.

When the LiₓA_{y}D_{z}PO₄ particles are mixed in a state where a heat treatment is not performed, the Li source, the Fe source, and the PO₄ source are uniformly present on the surfaces of the particles, and thus the carbon film is likely to be uniformly formed.

On the other hand, when a heat treatment is performed at a high temperature at the LiFePO₄ particles can be formed, in the state of the LiFePO₄ particles, Fe is not likely to be attached to the LiₓA_{y}D_{z}PO₄ particles. Therefore, a desired amount of Fe cannot be made to be present on the surfaces of the LiₓA_{y}D_{z}PO₄ particles.

Examples of the organic compound include polyvinyl alcohol, polyvinyl pyrrolidone, cellulose, starch, gelatin, carboxymethyl cellulose, methyl cellulose, hydroxymethyl cellulose, hydroxyethyl cellulose, polyacrylic acid, polystyrene sulfonic acid, polyacrylamide, polyvinyl acetate, glucose, fructose, galactose, mannose, maltose, sucrose, lactose, glycogen, pectin, alginic acid, glucomannan, chitin, hyaluronic acid, chondroitin, agarose, polyether, and polyols.

Examples of the polyols include polyethylene glycol, polypropylene glycol, polyglycerin, and glycerin.

The organic compound may be mixed such that the content rate of carbon in the organic compound is 0.5 part by mass or more and 2.5 parts by mass or less with respect to 100 parts by mass of the LiₓA_{y}D_{z}PO₄ particles.

Next, the obtained mixed liquid is dispersed to obtain a dispersion.

A dispersion method is not particularly limited, and a device is preferable that is capable of applying dispersion energy to the extent that the agglomerated state of the LiₓA_{y}D_{z}PO₄ particles can be disentangled such that the LiFePO₄ precursor particles are likely to be scattered and attached to the surfaces of the individual LiₓA_{y}D_{z}PO₄ particles. Examples of the disperser include a ball mill, a sand mill, and a planetary mixer. In particular, by using a continuous disperser, sampling can be performed during the dispersion, and an end point can be easily determined using a span value.

Next, the dispersion is dried to obtain a dry material.

In this step, a drying method is not particularly limited as long as a solvent (water) can be removed from the dispersion.

In order to prepare agglomerated particles, the dispersion is dried using a spray drying method. For example, a method of spraying the dispersion in a high temperature atmosphere at 100° C. or higher and 300° C. or lower to obtain a particulate dry material or a granular dry material can be used.

Next, the dry material is calcinated in a non-oxidative atmosphere in a temperature range of 700° C. or higher and 1000° C. or lower and preferably 800° C. or higher and 900° C. or lower.

As the non-oxidative atmosphere, an inert atmosphere such as nitrogen (N₂) or argon (Ar) is preferable, and when it is desired to further suppress oxidation, a reducing atmosphere including reducing gas such as hydrogen (H₂) is preferable.

Here, the reason why the calcination temperature of the dry material is 700° C. or higher and 1000° C. or lower is that, it is not preferable that the calcination temperature is lower than 700° C. because the decomposition reaction of the organic compound included in the dry material do not sufficiently progress, the carbonization of the organic compound is insufficient, and the produced decomposition reaction product is a high-resistance organic decomposition product. On the other hand, it is not preferable that the calcination temperature is higher than 1000° C. because a component constituting the dry material, for example, lithium (Li) is evaporated such that the composition deviates, particle growth in the dry material is promoted, the discharge capacity at a high charge-discharge rate decreases, and it is difficult to realize sufficient charge and discharge rate performance.

The calcination time is not particularly limited as long as the organic compound can be sufficiently carbonized. For example, the calcination time is 0.1 hours or longer and 10 hours or shorter.

Through the calcination, a granulated body that is produced using the primary particles of the carbon-coated electrode active material can be obtained.

Next, the obtained granulated body is mixed with the oxide electrode active material at a predetermined ratio to obtain the electrode material for lithium-ion secondary batteries according to the embodiment.

A method of mixing the granulated body and the oxide electrode active material with each other is not particularly limited and it is preferable to use a device capable of uniformly mixing the granulated body and the oxide electrode active material with each other. Examples of the device include a ball mill, a sand mill, and a planetary mixer.

[Positive Electrode for Lithium-Ion Secondary Batteries]

The positive electrode for lithium-ion secondary batteries according to the embodiment includes: an electrode current collector; and a positive electrode mixture layer (electrode) that is formed on the electrode current collector, in which the positive electrode mixture layer includes the positive electrode material for lithium-ion secondary batteries according to the embodiment.

That is, in the positive electrode for lithium-ion secondary batteries according to the embodiment, the positive electrode mixture layer is formed on one main surface of the electrode current collector using the positive electrode material for lithium-ion secondary batteries according to the embodiment.

A method of manufacturing the positive electrode for lithium-ion secondary batteries according to the embodiment is not particularly limited as long as the positive electrode mixture layer can be formed on one main surface of the electrode current collector using the positive electrode material for lithium-ion secondary batteries according to the embodiment. Examples of the method of manufacturing the positive electrode for lithium-ion secondary batteries according to the embodiment include the following method.

First, the positive electrode material for lithium-ion secondary batteries according to the embodiment, a binder, a conductive auxiliary agent, and a solvent are mixed with each other to prepare a positive electrode material paste for lithium-ion secondary batteries.

[Binder]

The binder is not particularly limited as long as it is an aqueous binder. Examples of the binder include at least one selected from the group consisting of polyethylene, polypropylene, polyethylene terephthalate, polymethyl methacrylate, a vinyl acetate copolymer, styrene-butadiene latex, acrylic latex, acrylonitrile-butadiene latex, fluorine latex, silicon latex, and the like.

When the total mass of the positive electrode material for lithium-ion secondary batteries according to the embodiment, the binder, and the conductive auxiliary agent is represented by 100% by mass, the content rate of the binder in the positive electrode material paste for lithium-ion secondary batteries is preferably 1% by mass or more and 10% by mass or less and more preferably 2% by mass or more and 6% by mass or less.

### [Conductive Auxiliary Agent]

The conductive auxiliary agent is not particularly limited, and for example, at least one selected from the group acetylene black, Ketjen black, Furnace black, and filamentous carbon such as vapor-grown carbon fiber (VGCF) or carbon nanotube is used.

When the total mass of the positive electrode material for lithium-ion secondary batteries according to the embodiment, the binder, and the conductive auxiliary agent is represented by 100% by mass, the content rate of the conductive auxiliary agent in the positive electrode material paste for lithium-ion secondary batteries is preferably 1% by mass or more and 15% by mass or less and more preferably 3% by mass or more and 10% by mass or less.

### [Solvent]

The solvent may be appropriately added to the positive electrode material paste for lithium-ion secondary batteries including the positive electrode material for lithium-ion secondary batteries according to the embodiment so as to easily coat a coating object such as the electrode current collector with the paste.

The solvent is mainly formed of water and may optionally include an aqueous solvent such as an alcohol, a glycol, or an ether within a range where the characteristics of the positive electrode material for lithium-ion secondary batteries according to the embodiment do not deteriorate.

When the total mass of the positive electrode material for lithium-ion secondary batteries according to the embodiment, the binder, and the solvent is represented by 100 parts by mass, the content rate of the solvent in the positive electrode material paste for lithium-ion secondary batteries is preferably 60 parts by mass or more and 400 parts by mass or less and more preferably 80 parts by mass or more and 300 parts by mass.

By controlling the content of the solvent to be in the above-described range, the positive electrode material paste for lithium-ion secondary batteries having good electrode formability and good battery characteristics can be obtained.

A method of mixing the positive electrode material for lithium-ion secondary batteries according to the embodiment, the binder, the conductive auxiliary agent, and the solvent with each other is not particularly limited as long as it is a method capable of uniformly mixing the components. For example, a method of using a kneader such as a ball mill, a sand mill, a planetary mixer, a paint shaker, or a homogenizer can be used.

Next, one main surface of the electrode current collector is coated with the positive electrode material paste for lithium-ion secondary batteries to form a film thereon, and this coating film is dried and compressed. As a result, the positive electrode for lithium-ion secondary batteries in which the positive electrode mixture layer is formed on the main surface of the electrode current collector can be obtained.

The positive electrode for lithium-ion secondary batteries according to the embodiment includes the positive electrode material for lithium-ion secondary batteries according to the embodiment. Therefore, an electrolytic solution easily penetrates into the granulated body included in the positive electrode for lithium-ion secondary batteries, and a positive electrode for lithium-ion secondary batteries in which the electron conductivity and the ion conductivity are realized and the energy density is improved can be provided.

[Lithium-Ion Secondary Battery]

The lithium-ion secondary battery according to the embodiment includes a positive electrode, a negative electrode, and a non-aqueous electrolyte, in which the positive electrode for lithium-ion secondary batteries according to the embodiment is provided as the positive electrode.

In the lithium-ion secondary battery according to the embodiment, the negative electrode, the non-aqueous electrolyte, the separator, and the like are not particularly limited.

The negative electrode can be formed of, for example, a negative electrode material such as metal Li, a carbon material, a Li alloy, or Li₄Ti₅O₁₂.

In addition, a solid electrolyte may be used instead of the non-aqueous electrolyte and the separator.

The non-aqueous electrolyte can be prepared by mixing ethylene carbonate (EC) and ethyl methyl carbonate (EMC) with each other at a volume ratio of 1:1 to obtain a mixed solvent, and dissolving lithium hexafluorophosphate (LiPF₆) in the obtained mixed solvent such that the concentration thereof is, for example, 1 mol/dm³.

As the separator, for example, porous propylene can be used.

The lithium-ion secondary battery according to the embodiment includes the positive electrode for lithium-ion secondary batteries according to the embodiment. Therefore, the discharge capacity is high, and the charge-discharge direct current resistance is low.

### EXAMPLES

Hereinafter, the present invention will be described in detail using Examples and Comparative Examples, but is not limited to the following examples.

### Production Example 1

[Production of Positive Electrode Active Material (LiFePO₄)]

Lithium hydroxide (LiOH) was used as a Li source, ammonium dihydrogen phosphate (NH₄H₂PO₄) was used as a P source, and iron (II) sulfate heptahydrate (FeSO₄.7H₂O) was used as a Fe source.

Lithium hydroxide, ammonium dihydrogen phosphate, and iron (II) sulfate heptahydrate were mixed with pure water such that a mass ratio Li:Fe:P=3:1:1 and the total amount thereof was 200 mL. As a result, a uniform slurry-like mixture was prepared.

Next, this mixture was accommodated in a pressure-resistant airtight container having a volume of 500 mL, and hydrothermal synthesis was performed at 170° C. for 12 hours.

After the reaction, the reaction solution was cooled to room temperature (25° C.), and a precipitated cake reaction product was obtained.

Next, this precipitate (reaction product) was sufficiently cleaned with distilled water, and pure water was added to prevent drying and to maintain the water content at 30%. As a result, a cake-like material was obtained.

A small amount of the cake-like material was collected and was dried in a vacuum state at 70° C. for 2 hours to obtain powder. The powder was analyzed by X-ray diffraction measurement (X-ray diffractometer: RINT 2000, manufactured by Rigaku Corporation). As a result, it was verified that single-phase LiFePO₄ was formed.

### Production Example 2

[Production of Positive Electrode Active Material (Li[Fe_{0.25}Mn_{0.75}]PO₄]

Li[Fe_{0.25}Mn_{0.75}]PO₄ was synthesized using the same method as that of Production Example 1, except that a mixture (FeSO₄.7H₂O:MnSO₄:H₂O=25:75 (material mass ratio) of iron (II) sulfate heptahydrate (FeSO₄.7H₂O) manganese (II) sulfate monohydrate (MnSO₄.H₂O) was used as the Fe source.

### Example 1

20 g of LiFePO₄ (positive electrode active material) obtained in Production Example 1 and 0.73 g of sucrose as a carbon source were mixed with water such that the total amount was 100 g. As a result, a mixed liquid was prepared. 150 g of zirconia beads having a diameter of 0.1 mm as medium particles were added to the mixed liquid, and the mixed liquid was dispersed using a bead mill while adjusting the stirring rate and the stirring time until a span value became 0.8, the span value being calculated from a particle diameter (D90) corresponding to a cumulative percentage of 90%, a particle diameter (D50) corresponding to a cumulative percentage of 50%, and a particle diameter (D10) corresponding to a cumulative percentage of 10% in a cumulative particle diameter distribution. In the obtained slurry, the particle diameter (d50) corresponding to a cumulative volume percent of 50% in the particle diameter distribution was 100 nm, and the span value of the dispersion was 0.8.

Next, the obtained slurry was dried and granulated using a spray dryer such that the drying outlet temperature was 60° C. As a result, a granulated powder was obtained.

Next, a heat treatment was performed on the granulated powder using a tube furnace at a temperature of 770° C. for 2 hours. As a result, a positive electrode material according to Example 1 that was produced using the granulated body formed of the primary particles of the carbon-coated positive electrode active material was obtained.

### Example 2

A positive electrode material according to Example 2 that was produced using the granulated body formed of the primary particles of the carbon-coated positive electrode active material was obtained using the same method as that of Example 1, except that the stirring rate and the stirring time were changed such that the span value at the end of the slurry dispersion was 0.6.

### Example 3

A positive electrode material according to Example 3 that was produced using the granulated body formed of the primary particles of the carbon-coated positive electrode active material was obtained using the same method as that of Example 1, except that the stirring rate and the stirring time were changed such that the span value at the end of the slurry dispersion was 5.0.

### Example 4

A positive electrode material according to Example 3 that was produced using the granulated body formed of the primary particles of the carbon-coated positive electrode active material was obtained using the same method as that of Example 1, except that the stirring rate and the stirring time were changed such that the span value at the end of the slurry dispersion was 12.

### Example 5

A positive electrode material according to Example 4 that was produced using the granulated body formed of the primary particles of the carbon-coated positive electrode active material was obtained using the same method as that of Example 1, except that Li[Fe_{0.25}Mn_{0.75}]PO₄ obtained in Production Example 2 was used as the positive electrode active material instead of LiFePO₄.

### Comparative Example 1

A positive electrode material according to Comparative Example 1 that was produced using the granulated body formed of the primary particles of the carbon-coated positive electrode active material was obtained using the same method as that of Example 1, except that the dispersion liquid was prepared by mixing using a stirring bar instead of zirconia beads and the span value was 23.

### Preparation of Lithium Ion Battery

The positive electrode materials obtained in each of Examples 1 to 4 and Comparative Example 1, polyvinylidene fluoride (PVdF) as a binder, and acetylene black (AB) as a conductive auxiliary agent were added to N-methyl-2-pyrrolidinone (NMP) such that a mass ratio (positive electrode material:AB:PVdF) thereof in the paste was 90:5:5, and the components were mixed with each other to prepare a positive electrode material paste.

Next, this positive electrode material paste was applied to a surface of aluminum foil (electrode current collector) having a thickness of 30 μm to form a coating film, and this coating film was dried to form a positive electrode mixture layer on the surface of the aluminum foil. Next, the positive electrode mixture layer was pressed such that a predetermined density was obtained. As a result, an electrode plate for a positive electrode was obtained. Using a forming machine, the obtained electrode plate for a positive electrode was punched into a plate shape including a positive electrode mixture layer having a 3 cm (length)×3 cm (width) rectangular shape (electrode area: 9 cm²) and a space for a tab.

Next, an electrode tab was welded to the space for a tap of the electrode plate to prepare a test electrode (positive electrode).

A coated electrode as a negative electrode was arranged on the test electrode with a separator formed of a porous polypropylene membrane interposed therebetween. As a result, a member for a battery was obtained.

The coated electrode was formed by applying a mixture to the separator, the mixture being obtained by mixing natural graphite, acetylene black (AB), styrene-butadiene rubber (SBR), and carboxymethyl cellulose (CMC) such that a mass ratio natural graphite:AB:SBR:CMC thereof was 92:4:3:1.

The prepared positive electrode and the prepared negative electrode were arranged to face each other with a separator formed of porous polypropylene having a thickness of 20 μm interposed therebetween, the laminate was dipped in 0.5 mL of a 1 mol/L lithium hexafluorophosphate (LiPF6) solution as a non-aqueous electrolytic solution, and the laminate film was sealed to prepare a lithium-ion secondary battery. In order to obtain the LiPF6 solution, ethylene carbonate and diethyl carbonate were mixed with each other at a volume ratio of 1:1, and 2% vinylene carbonate as an additive was added thereto.

[Evaluation of Positive Electrode Material]

The positive electrode material obtained in each of Examples 1 to 4 and Comparative Example 1 and components included in the positive electrode material were evaluated. Evaluation methods are as follows. The results are shown in Table 1.

### (1) Particle Diameter Distribution and Span Value of Positive Electrode Active Material Included in Dispersion Liquid

Using a particle diameter distribution analyzer (trade name: LA-920, manufactured by Horiba Ltd.), the particle diameter distribution of the positive electrode active material in the dispersion liquid including the positive electrode active material and water was measured with a method according to JIS Z 8825 “Particle Size Analysis—Laser Diffraction Methods—”.

Using the measurement result of the particle diameter distribution, the span value of the particle diameter distribution of the positive electrode active material in the dispersion liquid was calculated.

Span Value=(D90−D10)/D50

### (2) Crystallite Diameter of Positive Electrode Active Material

The crystallite diameter of the positive electrode active material was calculated from the Scherrer equation using a full width at half maximum of a diffraction peak and a diffraction angle (2θ) of the (020) plane in a powder X-ray diffraction pattern that is measured by X-ray diffraction measurement (X-ray diffractometer: RINT 2000 (trade name), manufactured by Rigaku Corporation).

### (3) Pore Volume of Positive Electrode Active Material

Using a specific surface area/pore distribution measuring device (trade name: BELSORP-mini, manufactured by MicrotracBEL Corp.), the pore volume of the positive electrode active material was measured using gas adsorption. Based on analysis using a BJH method, the cumulative pore volume distribution of the positive electrode material in a pore size range of 1 nm or more and 100 nm or less was obtained.

By plotting the pore size on the horizontal axis and plotting the cumulative pore volume on the vertical axis, a volume of pores (A) having a pore size of 2 nm to 100 nm was calculated from a difference between a cumulative volume of pores having a pore size of 2 nm and a cumulative volume of pores having a pore size of 100 nm.

Likewise, a volume of pores (B) having a pore size of 20 nm to 70 nm was calculated from a difference between a cumulative volume of pores having a pore size of 20 nm and a cumulative volume of pores having a pore size of 70 nm.

### (4) Pore Volume During Compression of Positive Electrode Active Material

1 g of the positive electrode active material was introduced into a cylindrical container having a diameter of ϕ2 cm, and a pressure of 25 MPa was applied from the top. As a result, compressed powder was obtained.

By measuring the obtained powder using the same method as that of (3), a volume of pores (C) having a pore size of 20 nm to 70 nm was calculated.

### (5) Pore Volume Ratio

By calculating a ratio (volume of pores B/volume of pores A) of the volume of pores (B) calculated in (3) to the volume of pores (A) calculated in (3), a ratio of the volume of pores having a pore size of 20 nm to 70 nm to the volume of pores having a pore size of 2 nm to 100 nm was calculated.

(6) Retention of Pore volume

By calculating a ratio (volume of pores C/volume of pores B) of the volume of pores (C) calculated in (3) to the volume of pores (B) calculated in (4), a retention of the volume of pores having a pore size of 20 nm to 70 nm during pressing was calculated.

[Evaluation of Positive Electrode and Lithium-Ion Secondary Battery]

Using the lithium-ion secondary battery obtained in each of Examples 1 to 4 and Comparative Example 1, the discharge capacity and the charge-discharge direct current resistance (DCR) were measured. Evaluation methods are as follows. The results are shown in Table 1.

### (1) Discharge Capacity

At an environmental temperature of 25° C., the cut-off voltage was set as 2.5 V-3.7 V (vs carbon negative electrode) in the batteries other than Example 3, and the cut-off voltage was set as 2.5 V-4.2 V (vs carbon negative electrode) in the batteries according to Example 3, the charge current was set as 1 C, the discharge current was set as 3 C, and the discharge capacity of the lithium-ion secondary battery was measured by constant-current charging and discharging.

### (2) Charge-Discharge Direct Current Resistance (DCR)

The lithium-ion secondary battery was charged at a current of 0.1 C at an environmental temperature of 0° C. for 5 hours and the charge depth was adjusted (state of charge (SOC) 50%). Regarding the battery adjusted to SOC 50%, “charging at 1 C for 10 seconds→rest for 10 minutes→discharging at 1 C for 10 seconds→rest for 10 minutes” as a first cycle, “charging at 3 C for 10 seconds→rest for 10 minutes→discharging at 3 C for 10 seconds→rest for 10 minutes” as a second cycle, “charging at 5 C for 10 seconds→rest for 10 minutes→discharging at 5 C for 10 seconds→rest for 10 minutes” as a third cycle, and “charging at 10 C for 10 seconds→rest for 10 minutes→discharging at 10 C for 10 seconds→rest for 10 minutes” as a fourth cycle were performed in this order. At this time, the voltage was measured 10 seconds after every charging and discharging. An approximation straight line was plotted on a graph in which the horizontal axis represents each current value and the vertical axis represents the voltage after 10 seconds. Respective slopes of the approximation straight lines were obtained as a direct current resistance during charging (charge DCR) and a direct current resistance during discharging (discharge DCR).

TABLE 1

| | | | Volume | Ratio B/A of | Retention | | | |
|---|---|---|---|---|---|---|---|---|
| | | | (cm³/g) of | Volume of | C/B of | | | |
| | | | Pores having | Pores having | Volume of | 3 C | | |
| | | Crystallite | Pore Size of | Pore Size | Pores | Discharge | Charge | |
| | Span | Diameter | 2 nm to | of 20 nm to | during | Volume | DCR | Discharge |
| | Value | (nm) | 100 nm | 70 nm | Compression | (mAh/g) | (Ω) | DCR (Ω) |
| Example 1 | 0.8 | 85 | 0.13 | 0.78 | 0.97 | 138 | 2.4 | 1.8 |
| Example 2 | 0.6 | 83 | 0.12 | 0.81 | 1.00 | 135 | 2.6 | 1.9 |
| Example 3 | 5.0 | 88 | 0.15 | 0.75 | 0.96 | 133 | 2.7 | 2.1 |
| Example 4 | 12 | 90 | 0.16 | 0.72 | 0.78 | 131 | 2.6 | 2.2 |
| Example 5 | 0.8 | 65 | 0.14 | 0.84 | 0.87 | 125 | 2.9 | 2.5 |
| Comparative | 23 | 91 | 0.20 | 0.72 | 0.72 | 120 | 3.2 | 2.9 |
| Example 1 | | | | | | | | |

In the results of Table 1, in Examples 1 to 5, the discharge capacity increased, and the direct current resistance also decreased.

On the other hand, in Comparative Example 1, the discharge capacity decreased, and the direct current resistance increased.

That is, when Examples 1 to 5 were compared to Comparative Example 1, it was found that the discharge capacity was high and the charge-discharge direct current resistance was low.

### INDUSTRIAL APPLICABILITY

The positive electrode material for lithium-ion secondary batteries according to the present invention includes a granulated body in which a volume of pores having a pore size of 2 nm to 100 nm calculated from a cumulative pore volume distribution is 0.1 cm³/g or higher and 0.2 cm³/g or lower and a ratio of a volume of pores having a pore size of 20 nm to 70 nm is 65% or higher with respect to 100% of the volume of pores having a pore size of 2 nm to 100 nm. Therefore, the positive electrode for lithium-ion secondary batteries that is produced using the positive electrode material for lithium-ion secondary batteries has excellent electron conductivity. Accordingly, in the lithium-ion secondary battery including the positive electrode for lithium-ion secondary batteries, the charge-discharge direct current resistance was low, and the discharge capacity was high. Therefore, the lithium-ion secondary battery is applicable to the next-generation secondary battery in which high voltage, high energy density, high load characteristics, and high-speed charge and discharge characteristics are expected. In the case of the next-generation secondary battery, the effects are significant.

1. A positive electrode material for lithium-ion secondary batteries comprising a granulated body in which
a volume of pores having a pore size of 2 nm to 100 nm calculated from a cumulative pore volume distribution is 0.1 cm³/g or higher and 0.2 cm³/g or lower and
a ratio of a volume of pores having a pore size of 20 nm to 70 nm is 65% or higher with respect to 100% of the volume of pores having a pore size of 2 nm to 100 nm.

2. The positive electrode material for lithium-ion secondary batteries according to claim 1,
wherein when a pressure of 25 MPa is applied to the granulated body, a retention of a volume of pores having a pore size of 20 nm to 70 nm calculated from a cumulative pore volume distribution is 75% or higher.

3. The positive electrode material for lithium-ion secondary batteries according to claim 1,
wherein the granulated body includes:
primary particles represented by LiₓA_{y}D_{z}PO₄
wherein A represents at least one selected from the group consisting of Co, Mn, Ni, Fe, Cu, and Cr, D represents at least one selected from the group consisting of Mg, Ca, Sr, Ba, Ti, Zn, B, Al, Ga, In, Si, Ge, Sc, and Y, 0.9<x<1.1, 0<z=1, and 0.9<y+z<1.1; and
a carbon film that coats surfaces of the primary particles.

4. A positive electrode for lithium-ion secondary batteries, the positive electrode comprising:
an electrode current collector; and
a positive electrode mixture layer that is formed on the electrode current collector,
wherein the positive electrode mixture layer includes the positive electrode material for lithium-ion secondary batteries according to claim 1.

5. A lithium-ion secondary battery comprising:
a positive electrode according to claim 4;
a negative electrode; and
a non-aqueous electrolyte.
